(19) United States
(12) Patent Application Publication
(10) Pub. No.: US 2017/0002723 A1
(43) Pub. Date: Jan. 5, 2017

(54) SPARK-IGNITION INTERNAL COMBUSTION ENGINE

(71) Applicant: TOYOTA JIDOSHA KABUSHIKI KAISHA, Toyota-shi, Aichi-ken (JP)

(72) Inventor: Kotaro SUZUKI, Minamiashigara-shi (JP)

(73) Assignee: TOYOTA JIDOSHA KABUSHIKI KAISHA, Toyota-shi, Aichi-ken (JP)

(21) Appl. No.: 15/125,678

(22) PCT Filed: Mar. 9, 2015
(86) PCT No.: PCT/IB2015/000296

§ 371 Date: Sep. 13, 2016

(30) Foreign Application Priority Data
Mar. 17, 2014 (JP) 2014-053700

(51) Int. Cl. F02B 23/10

(52) U.S. Cl. CPC F02B 23/10; F02B 2023/106

(57) ABSTRACT

A spark-ignition internal combustion engine includes a pent roof type combustion chamber, intake valves, exhaust valves, ignition plug, and an airflow guide member. The airflow guide member is provided on a housing of the ignition plug or a wall surface of at least one of pair of roofs. The airflow guide member is configured to deflect airflow that passes through the discharge gap at the time of ignition, in a direction that is inclined relative to a reference direction perpendicular to a line of intersection of wall surfaces of the pair of roofs as viewed in a direction of a center axis of a cylinder. A connecting portion of the ignition plug is located outside a direction of the airflow deflected by the airflow guide member.

### BACKGROUND OF THE INVENTION

1. Field of the Invention

The invention relates to a spark-ignition internal combustion engine.

2. Description of Related Art

One example of spark-ignition internal combustion engine is disclosed in Japanese Patent Application Publication No. 2013-098042 (JP 2013-098042 A). The internal combustion engine has an ignition plug including a plug body mounted in a cylinder head, a center electrode provided on the plug body, and a ground electrode. The ground electrode has an opposed portion that is opposed to the center electrode via a discharge gap in an axial direction of the plug body, and a connecting portion that connects the opposed portion to a housing of the plug body. The plug body is mounted in the cylinder head, such that a direction of the connecting portion as viewed from the center electrode is perpendicular to a direction of airflow around the ignition plug, as viewed in the axial direction of the plug body.

### SUMMARY OF THE INVENTION

In the meantime, one type of internal combustion engine includes a pent roof type combustion chamber having a pair of roofs that are inclined so as to be opposed to each other, and an intake valve or valves is/are disposed on one of the pair of roofs while an exhaust valve or valves is/are disposed on the other of the pair of roofs. Also, an ignition plug is mounted at the top of the combustion chamber at which the pair of roofs intersect with each other. This type of engine has the following problem in connection with the ignition performance of an air-fuel mixture ignited by the ignition plug. Namely, in the above-described engine, when airflow directed from one of the roofs toward the other roof, or airflow directed from the other roof toward one of the roofs is produced as airflow that passes through the discharge gap at the time of ignition, a discharge spark formed in the discharge gap may extend toward a ceiling surface of the combustion chamber (i.e., a wall surface of one or the other roof) along with the airflow. In this case, the extended discharge spark gets close to the ceiling surface of the combustion chamber, whereby an initial flame generated from the discharge spark may be brought into contact with the ceiling surface, and the heat of the initial frame may be lost to the ceiling surface, resulting in extinction of the flame. Consequently, the ignition performance may deteriorate.

In order to prevent deterioration of the ignition performance due to extinction of the initial flame, it is necessary to curb or prevent contact of the initial flame with the ceiling surface of the combustion chamber. However, the arrangements around the ignition plug in internal combustion engines that are already in use or have been proposed, including the arrangement disclosed in the above-identified patent publication, are not devised to curb or prevent contact of the initial flame with the ceiling surface of the combustion chamber.

This invention provide a spark-ignition internal combustion engine that can curb or prevent contact of an initial flame generated from a discharge spark of an ignition plug with a ceiling surface of a combustion chamber.

A spark-ignition internal combustion engine according to one embodiment of the invention includes a pent roof type combustion chamber, at least one intake valve, at least one exhaust valve, an ignition plug, and an airflow guide member. The pent roof type combustion chamber has a pair of roofs that are inclined so as to be opposed to each other. The above-indicated at least one intake valve is disposed on one of the pair of roofs. The above-indicated at least one exhaust valve is disposed on the other of the pair of roofs. The ignition plug includes a plug body, a center electrode and a ground electrode. The plug body is mounted in a cylinder head at a top of the combustion chamber at which the pair of roofs intersect with each other. The center electrode is provided on the plug body. The ground electrode includes an opposed portion and a connecting portion. The opposed portion is opposed to the center electrode via a discharge gap in an axial direction of the plug body. The connecting portion connects the opposed portion with a housing of the plug body. The airflow guide member is provided on the housing or a wall surface of at least one of the pair of roofs. The airflow guide member is configured to deflect airflow that passes through the discharge gap at the time of ignition, in a direction that is inclined relative to a reference direction that is perpendicular to a line of intersection of wall surfaces of the pair of roofs as viewed in a direction of a center axis of the cylinder. The airflow is a flow directed from the one of the pair of roofs to the other roof, or a flow directed from the other roof to the one of the pair of roofs. The connecting portion is located outside a direction of the airflow deflected by the airflow guide member.

According to the above aspect of the invention, a large distance can be secured between a discharge spark and an initial flame caused to flow downstream along with airflow passing through the discharge gap, and a ceiling surface of the combustion chamber located downstream of the discharge spark and initial flame. It is thus possible to curb or prevent contact of the initial flame generated from the spark plug with the ceiling surface of the combustion chamber.

In the internal combustion engine according to the above aspect of the invention, the airflow guide member may be configured to guide the airflow that passes through the discharge gap at the time of ignition, such that the airflow is directed to one side of a line of the reference direction which passes the center electrode, as viewed in the direction of the center axis of the cylinder, while the connecting portion of the ground electrode is located on the other side of the line of the reference direction.

With the above arrangement, the discharge spark and the initial flame are more reliably prevented from contacting with the ground electrode. Therefore, production of the initial flame can be effectively promoted.

In the internal combustion engine as described above, the ignition plug may be configured such that a discharge spark extends a larger distance than a distance from the discharge gap to the wall surface of the other roof as measured in a direction that is perpendicular to the line of intersection of the wall surfaces of the pair of roofs and perpendicular to the center axis of the cylinder.

In this type of the engine having the ignition plug, in which the discharge spark is likely to be extinguished due to contact with the ceiling surface of the combustion chamber, it is highly significant to curb or prevent contact of the initial flame with the ceiling surface of the combustion chamber.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a vertical cross-sectional view illustrating the structure of a combustion chamber of a spark-ignition internal combustion engine according to a first embodiment of the invention;

FIG. 2 is a view showing the configuration of an ignition plug shown in FIG. 1;

FIG. 3 is a view of the ignition plug as viewed from the piston side in a direction of a cylinder center axis;

FIG. 4A is a view concerning the arrangement of the related art referred to for comparison, showing a combustion chamber as viewed from the piston side in the direction of the cylinder center axis;

FIG. 4B is a view concerning the arrangement of the related art referred to for comparison, showing the combustion chamber as viewed in a direction perpendicular to a line of intersection of wall surfaces of a pair of roofs, and the cylinder center axis;

FIG. 5A is a view concerning the arrangement according to the first embodiment of the invention, showing the combustion chamber as viewed from the piston side in the direction of the cylinder center axis;

FIG. 5B is a view concerning the arrangement according to the first embodiment of the invention, showing the combustion chamber as viewed in the direction perpendicular to the line of intersection of the wall surfaces of the pair of roofs, and the cylinder center axis;

FIG. 6 is a view showing another example of airflow guide member according to the invention; and

FIG. 7 is a view showing another example of the location of the airflow guide member.

### DETAILED DESCRIPTION OF EMBODIMENTS

One embodiment of the invention will be described with reference to the drawings. In the embodiment, this invention is applied to a spark-ignition internal combustion engine for an automobile having an ignition plug, more particularly, a lean-burn internal combustion engine capable of operating in a homogeneous lean-burn mode. The lean-burn engine is desired to have improved ignition performance for expansion of the lean-burn limit. To this end, it is significant to apply this invention to the lean-burn engine. However, this invention may also be applied to an internal combustion engine that operates at the stoichiometric air-fuel ratio, and this type of engine can also provide a common advantageous effect, such as improvement of the ignition performance.

The embodiment as described below is provided for illustrating a device or method for embodying the technical concept of the invention, but is not intended to limit the structure, arrangement, etc. of constituent components to those as described below. This invention is not limited to the embodiment as described below, but may be implemented with various modifications or changes, without departing from the principle of the invention.

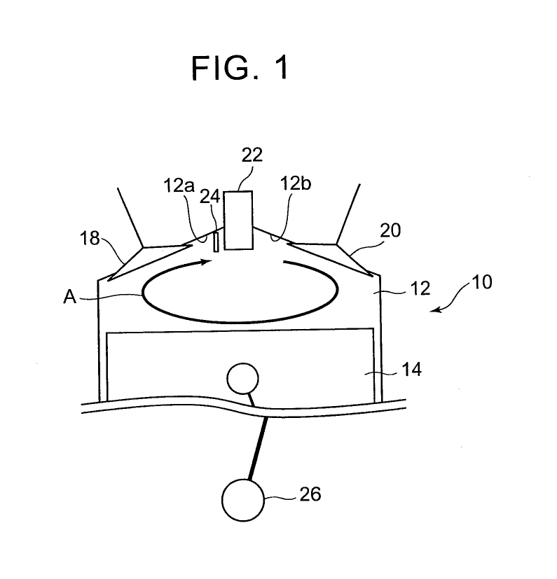

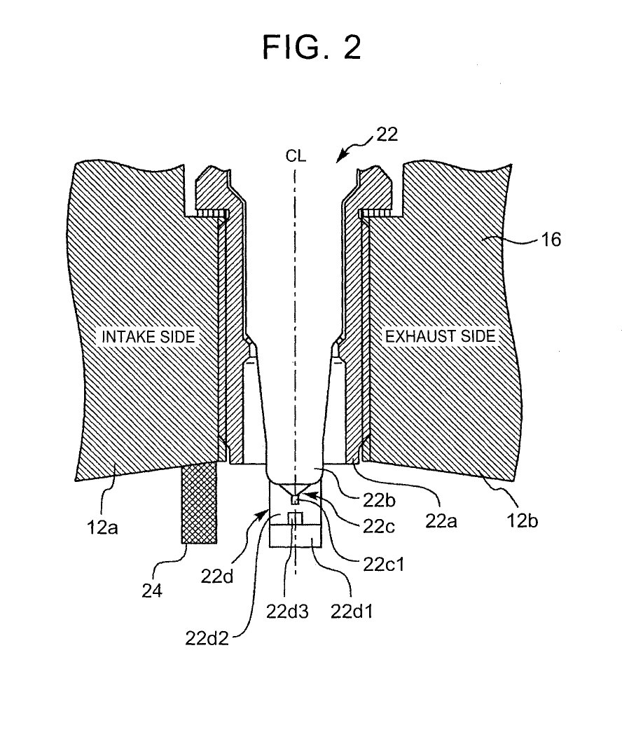

FIG. 1 is a vertical cross-sectional view illustrating the structure of a combustion chamber of a spark-ignition internal combustion engine 10 according to a first embodiment of the invention. The internal combustion engine 10 shown in FIG. 1 includes a pent roof type combustion chamber 12 having a pair of roofs 12a, 12b that are inclined so as to be opposed to each other. The combustion chamber 12 is a space surrounded by a top face of a piston 14 that reciprocates in each cylinder, and the pair of roofs 12a, 12b. The pair of roofs 12a, 12b are formed on a cylinder head 16 (see FIG. 2 that will be described later), and wall surfaces of the roofs 12a, 12b function as ceiling surfaces of the combustion chamber 12.

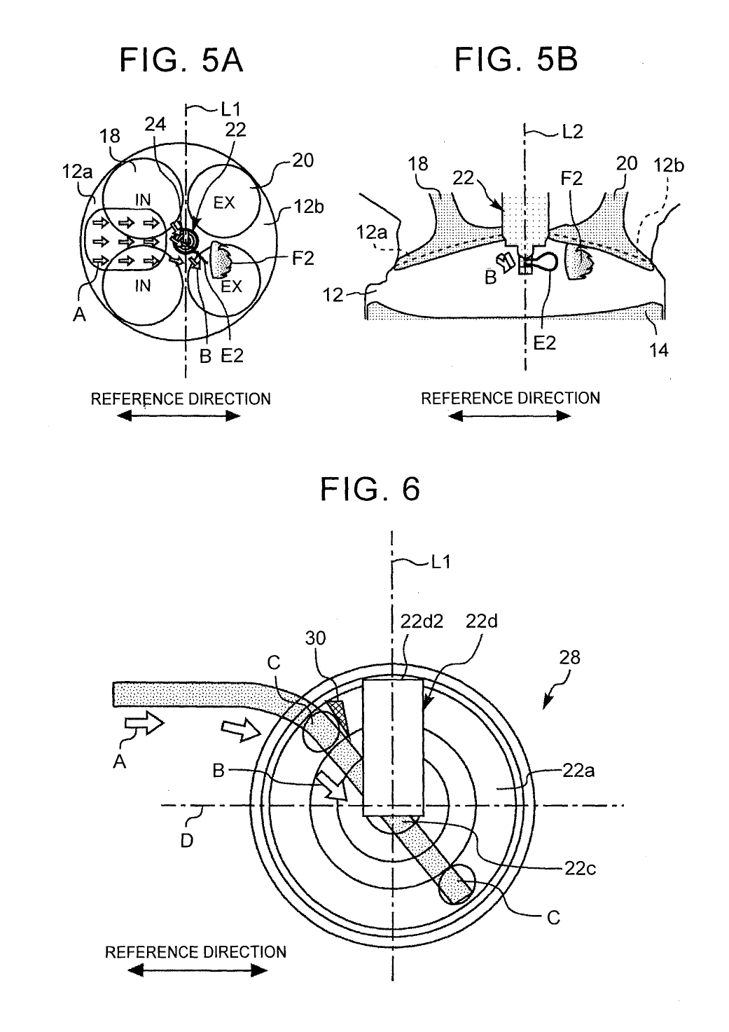

Two intake valves 18 are disposed side by side on one of the roofs 12a, and two exhaust valve 20 are disposed side by side on the other roof 12b (see FIG. 5A that will be described later). Also, an ignition plug 22 for igniting an air-fuel mixture is mounted at the top of the combustion chamber 12 where the roofs 12a, 12b intersect with each other.

In the meantime, airflow formed in the combustion chamber 12 takes various forms. In an example shown in FIG. 1, tumble flow that swirls clockwise from the intake valve 18 side toward the exhaust valve 20 side along the ceiling surface of the combustion chamber 12 is produced. In this example, the direction of airflow around the ignition plug 22 at the time of ignition is direction A (which is the same as “reference direction” as will be described later when the combustion chamber 12 is viewed in a direction of a cylinder center axis) from one roof 12a side (intake side) toward the other roof 12b side (exhaust side). The following description of this embodiment is based on the assumption that the direction of airflow around the ignition plug 22 at the time of ignition is the direction A of airflow shown in FIG. 1, for example.

FIG. 2 shows the configuration of the ignition plug 22 shown in FIG. 1. The ignition plug 22 according to this embodiment includes a cylindrical, metallic housing 22a mounted in the cylinder head 16, and a ceramic insulator 22b held inside the metallic housing 22a. The metallic housing 22a and the ceramic insulator 22b constitute a plug body of the ignition plug 22.

A distal end of the ceramic insulator 22b protrudes from the ceiling surface of the combustion chamber 12 into the combustion chamber 12. A center electrode 22c is provided on the protruding distal end of the ceramic insulator 22b. Further, a center electrode chip 22c1 is disposed on the distal end of the center electrode 22c, coaxially with the axis of the plug body, i.e., the axis CL of the ceramic insulator 22b.

A ground electrode 22d extends from the metallic housing 22a into the combustion chamber 12. The ground electrode 22d consists of an opposed portion 22d1 that is opposed to the center electrode 22c in the direction of the axis CL, and a connecting portion 22d2 that connects the opposed portion 22d1 to the metallic housing 22a. A ground electrode chip 22d3 is disposed on one side of the opposed portion 22d1 which is opposed to the center electrode 22c, coaxially with the axis CL of the ceramic insulator 22b. A clearance formed between the ground electrode chip 22d3 and the center electrode chip 22c1 provides a discharge gap in which spark discharge takes place.

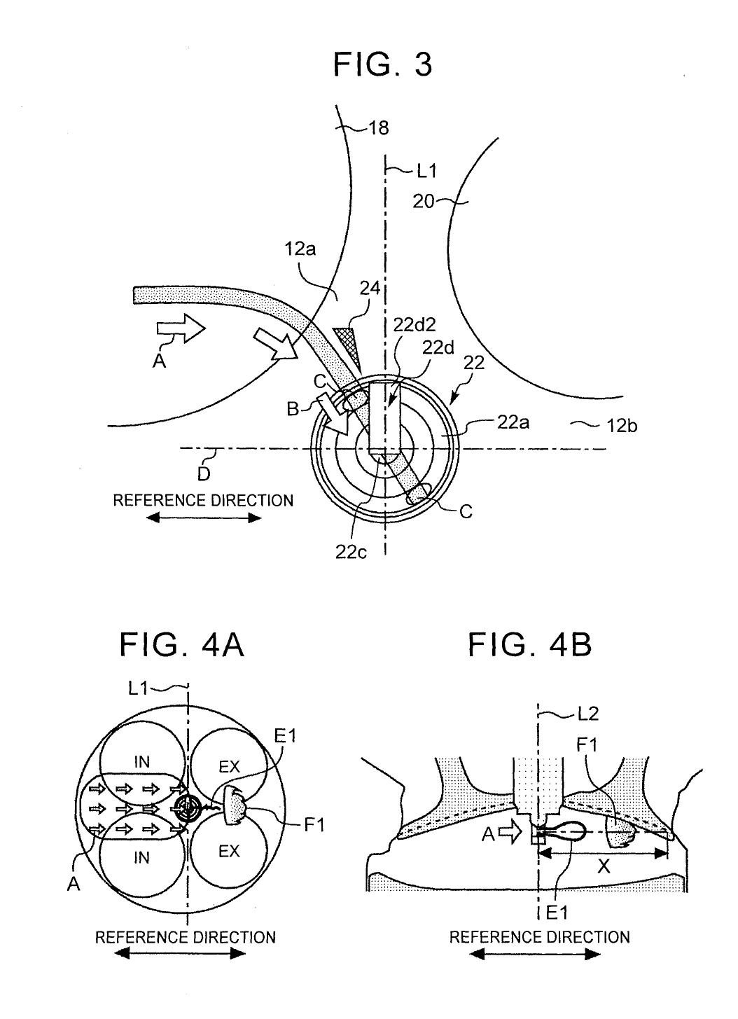

Referring next to FIG. 2 and FIG. 3, a characteristic arrangement of the internal combustion engine 10 will be described. FIG. 3 is a view of the ignition plug 22 taken in the direction of the cylinder center axis as viewed from the piston 14 side.

The internal combustion engine 10 of this embodiment is characterized in that an airflow guide member 24 is provided in the vicinity of the ignition plug 22, for deflecting airflow that passes through the discharge gap at the time of ignition, and that the plug body of the ignition plug 22 is mounted in the cylinder head 16 in view of the relationship with the direction of the airflow deflected by the airflow guide member 24.

More specifically, the airflow guide member 24 is provided on the ceiling surface (a wall surface of the intake-side roof 12a, in the example shown in FIG. 3) in the vicinity of the ignition plug 22. As shown in FIG. 3, the airflow that passes through the discharge gap at the time of ignition is deflected in a direction B that is inclined relative to the “reference direction” when the combustion chamber 12 is viewed in the direction of the cylinder center axis. The reference direction mentioned herein is a direction perpendicular to a line L1 of intersection of the roofs 12a, 12b when viewed in the direction of the cylinder center axis. In the case where a portion in which the wall surfaces of the pair of roofs intersect with each other is not acute-shaped (or sharp-shaped) but rounded, a hypothetical line of intersection obtained when the wall surfaces of the pair of roofs are hypothetically extended corresponds to the above-indicated line L1 of intersection. Also, in the internal combustion engine 10 of this embodiment, a crankshaft 26 (see FIG. 1) extends in such a manner as to divide the combustion chamber 12 into the intake side and the exhaust side when the engine 10 is viewed in the direction of the cylinder center line. Where the location of the intake and exhaust valves is related to the location of the crankshaft in this manner, the above-indicated “reference direction” is the same as the direction perpendicular to the crankshaft 26 when viewed in the direction of the cylinder center axis. In this connection, a direction A of airflow that passes through the discharge gap when the airflow is not deflected by the airflow guide member 24 is the same as the above-indicated reference direction. In the example shown in FIG. 3, the line L1 of intersection passes the center of the ignition plug 22 when viewed in the direction of the cylinder center axis.

In addition, the airflow guide member 24 is formed in the shape of a plate so as to extend toward the piston 14. Since the airflow guide member 24 is used for changing the direction of airflow that passes through the discharge gap as described above, the airflow guide member 24 is formed so as to protrude toward the piston 14, with a height equivalent to that of the ignition plug 22 as shown in FIG. 2. Also, the airflow guide member 24 is disposed on the airflow upstream side of the center electrode 22c as viewed in the above-indicated reference direction.

The ignition plug 22 is mounted in the cylinder head 16 with what will be stated below taken into consideration. More specifically, the plug body of the ignition plug 22 is mounted in the cylinder head 16; so that the connecting portion 22d2 of the ground electrode 22d is located outside the direction B of the airflow deflected by the airflow guide member 24. The location outside the direction B of the airflow comprises portions of a circumferential distal end face of the metallic housing 22a on which the connecting portion 22d2 is provided, from which excluded positions C as shown in FIG. 3 are excluded. If the connecting portion 22d2 is provided on the excluded position C, the connecting portion 22d2 will interfere with the airflow deflected by the airflow guide member 24 in the direction B of airflow and passed through the discharge gap.

In the example shown in FIG. 3, the plug body is mounted in the cylinder head 16, such that the connecting portion 22d2 of the ground electrode 22d is oriented in a direction of a clearance between the intake valve 18 and the exhaust valve 20. The direction B of airflow changes according to the position and shape of the airflow guide member 24, and the above-mentioned excluded positions C change according to change of the direction B of airflow. Accordingly, the mounting angle of the ignition plug 22 may be set as desired, within a range that satisfies a condition that the connecting portion 22d2 of the ground electrode 22d is provided in a portion other than the excluded positions C, in accordance with setting of the airflow direction B by the airflow guide member 24. The metallic housing 22a is formed with thread for mounting the ignition plug 22 in the cylinder head 16 so that the mounting angle of the ignition plug 22 becomes equal to a target angle.

In this embodiment, the airflow guide member 24 is arranged to guide airflow that passes through the discharge gap at the time of ignition, toward one side of the line D of the reference direction which passes the center electrode 22c, which side is opposite to the connecting portion 22d2 of the ground electrode 22d.

Furthermore, the ignition plug 22 of this embodiment is configured to produce discharge spark as described below. Namely, the ignition plug 22 is configured such that, if it is assumed that airflow that passes through the discharge gap causes a discharge spark to flow straight downstream in the direction A of airflow along the reference direction, as in the case shown in FIG. 4A and FIG. 4B as described later, the discharge spark would extend a larger distance than a distance X (see FIG. 4B) from the center electrode 22c to the ceiling surface of the combustion chamber 12 (the wall surface of the roof on the exhaust valve side) as measured in the reference direction. The configuration of the ignition plug 22 can be realized by reduction of the size of the ground electrode chip 22d3, for example.

Referring next to FIG. 4A, FIG. 4B, FIG. 5A and FIG. 5B, the operation and effect of the airflow guide member 24 constructed as described above will be described based on comparison with a known arrangement that does not include the airflow guide member 24. FIG. 4A and FIG. 4B are views regarding the arrangement of the related art to be referred to for comparison, and FIG. 5A and FIG. 5B are views regarding the arrangement according to the first embodiment of the invention. FIG. 4A, FIG. 4B, FIG. 5A and FIG. 5B show conditions of a discharge spark and an initial flame produced by the ignition plug. More specifically, FIG. 4A and FIG. 5A show the combustion chamber 12 as viewed in the direction of the cylinder center axis, from the piston 14 side. FIG. 4B and FIG. 5B show the combustion chamber 12 as viewed in a direction perpendicular to both the line L1 of intersection of the wall surfaces of the roofs 12a, 12b and the cylinder center line L2. The abovementioned “reference direction” is perpendicular to not only the line L1 of intersection, but also the direction of the cylinder center line as shown in FIG. 4B and FIG. 5B.

In the known arrangement, a discharge spark E1 formed between the center electrode chip and the ground electrode chip is caused to flow downstream in the direction A as the basic flow direction of tumble flow, due to the airflow that passes through the discharge gap. Namely, since the direction of the airflow is not changed, the discharge spark El extends as it is downstream in the airflow direction A. As a result, if the airflow in the cylinder is strong, the initial flame F1 produced from the discharge spark E1 contacts with the ceiling surface of the combustion chamber (the wall surface of the exhaust-side roof (including surfaces of exhaust valves that are in closed states). The contact of the initial flame F1 with the ceiling surface of the combustion chamber having a low temperature may cause poor ignition performance due to extinction of the initial flame F1. The deterioration of the ignition performance is particularly noticeable while the engine is operating in a lean burn mode.

The inventor of the invention observed the behavior of the discharge spark and initial flame immediately after discharge. According to the result of the observation, the inventor found that, when extinction of the initial flame takes place due to its contact with the ceiling surface, the discharge spark itself extends until it contacts with the ceiling surface. Accordingly, when the ignition plug is configured such that the discharge spark extends a larger distance than the above-indicated distance X, like the ignition plug 22 of this embodiment, the discharge spark itself is brought into contact with the ceiling surface, if the airflow in the cylinder is strong, whereby the initial flame is more likely to be extinguished.

On the other hand, FIG. 5A and FIG. 5B show conditions of a discharge spark and an initial flame produced by the ignition plug 22, in the case of the internal combustion engine 10 of this embodiment including the airflow guide member 24. Since the airflow is deflected by the airflow guide member 24, the direction of the airflow that passes through the discharge gap at the time of ignition changes from the direction A as the basic flow direction of tumble flow, to the direction B. More specifically, the flow direction of the tumble flow as a whole does not significantly change even if the airflow guide member 24 is provided,. However, if the flow direction of the airflow around the ignition plug 22 is changed, as shown in FIG. 5B, the direction in which the discharge spark E2 extends is influenced by the change in the airflow direction, whereby the discharge spark E2 extends in the direction B. Thus, in the internal combustion engine 10 having the pent roof type combustion chamber structure, when the discharge spark E2 extends downstream of the discharge gap, a large distance can be secured between the discharge spark E2 and the initial flame F2, and the ceiling surface of the combustion chamber 12 located downstream of the discharge spark E2 and the initial flam F3, as compared with the case where a discharge spark extends straight in the reference direction as shown in FIG. 4A and FIG. 4B. Therefore, the initial flame F2 produced from the discharge spark E2 is less likely or unlikely to contact with the ceiling surface of the combustion chamber 12. Namely, any contact of the initial flame F2 with the ceiling surface is avoided, or at least curbed, so that production of the initial flame F2 is promoted, and the ignition performance is improved. Thus, according to the internal combustion engine 10 of this embodiment, the lean burn limit can be expanded during lean-burn operation, and the engine can be operated at a leaner air-fuel ratio. Also, the arrangement of this embodiment is expected to provide a highly advantageous effect, particularly in the internal combustion engine in which strong tumble flow is produced.

In this embodiment, the airflow guide member 24 is configured to guide the airflow that passes through the discharge gap at the time of ignition, toward one side of the line D of the reference direction which passes the center electrode 22c , which side is opposite to the connecting portion 22d2 of the ground electrode 22d. With this arrangement, the connecting portion 22d2 of the ground electrode 22d is located on the airflow upstream side, relative to the initial flame F2 that extends in the direction B of the airflow that has been deflected by the airflow guide member 24. Consequently, the discharge spark E2 and the initial flame F2 are surely prevented from contacting with the ground electrode 22d. Therefore, production of the initial flame F2 can be more effectively promoted.

In addition, the problem that the initial flame is extinguished due to contact with the ceiling surface of the combustion chamber occurs prominently in the case where the ignition plug is configured such that the discharge spark extends a larger distance than the distance X shown in FIG. 4, as described above. Accordingly, the use of the airflow guide member 24 in this embodiment has a particularly high significance in the internal combustion engine having the ignition plug configured as described above, as in the internal combustion engine 10 including the ignition plug 22.

In the first embodiment as described above, the airflow guide member 24 is provided on the ceiling surface of the combustion chamber 12. However, the location of the airflow guide member according to the invention is not limited to the above-described location, but may be a location as indicated below with reference to FIG. 6. FIG. 6 shows another example of airflow guide member according to the invention. In the example of FIG. 6, an airflow guide member 30 having substantially the same function as the airflow guide member 24 is provided on the metallic housing 22a of the ignition plug 28. It is to be noted that the configuration of the internal combustion engine having the ignition plug 28 is identical with that of the above-described embodiment, except that the airflow guide member 30 is provided in place of the airflow guide member 24.

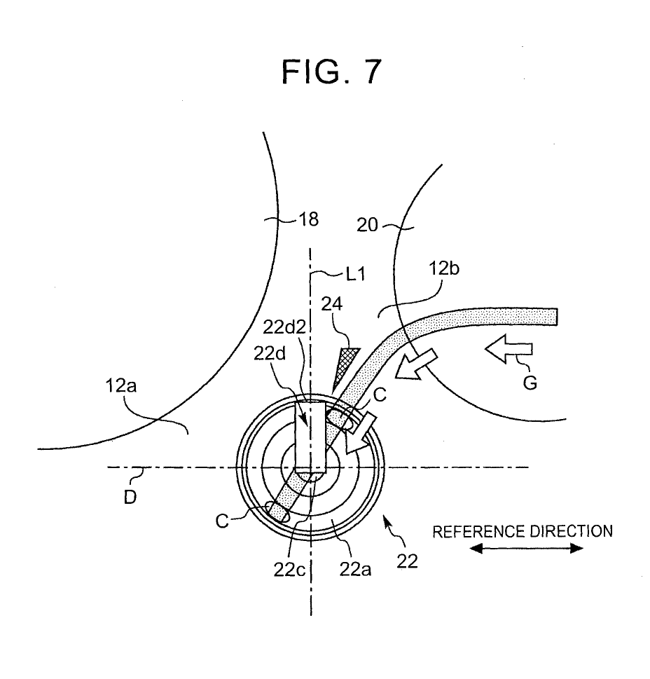

FIG. 7 shows another example of the location of the airflow guide member 24. In the internal combustion engine 10 of the first embodiment as described above, tumble flow is produced so that the direction of airflow around the ignition plug 22 at the time of ignition is direction A from one roof 12a side (intake side) to the other roof 12b side (exhaust side). However, contrary to this example, counterclockwise tumble flow may be produced which flows from the intake valves 18 toward the pair of exhaust valves 20 while swirling along the bottom of the combustion chamber 12 (or the top face of the piston 14), depending on the specifications of the engine. When the tumble flow is produced in this way, the basic flow direction of airflow around the ignition plug 22 at the time of ignition is direction G as shown in FIG. 7. In this case, the airflow guide member 24 is located upstream (the exhaust side, in this example) of the center electrode 22c as viewed in the reference direction. The above description also applies in the case where the airflow guide member 30 is provided on the ignition plug 28.

In some internal combustion engines, the direction or shape of airflow formed in the combustion chamber 12 changes depending on the operating region, as an effect produced from the structure of the engine, or due to the operation of a device for controlling airflow in the combustion chamber 12. More specifically, in some engines, the direction of airflow around the ignition plug at the time of ignition changes between the above-indicated direction A and the above-indicated direction G, depending on the operating region. If the ignition plug 22 and the airflow guide member 24, or the ignition plug 28 including the airflow guide member 30, is/are mounted in this type of engine, the location of the airflow guide member 24 or 30 and the angle of mounting of the ignition plug 22 or 28 may be determined with respect to a particular operating region. The operating region for which the location and angle are determined is preferably an operating region in which particularly high ignition performance is required. Accordingly, in the case of a lean-burn internal combustion engine that is selectively operated at the stoichiometric air-fuel ratio, or operated in a lean burn mode, depending on the operating region, the location of the airflow guide member 24 or 30 and the angle of mounting of the ignition plug 22 or 28 may be determined in accordance with the direction A or direction G of airflow in the operating region in which the engine is operated in the lean burn mode. Other than the measures as described above, a pair of airflow guide members corresponding to the direction A and direction G, respectively, may be provided, as needed, unless they have an adverse influence on the airflow in the cylinder.

In the first embodiment as described above, two intake valves 18 are disposed side by side on one roof 12a, and two exhaust valves 20 are disposed side by side on the other roof 12b. However, the numbers of intake valves and exhaust valves disposed on a pair of roofs of an internal combustion engine to which the invention is applied are not limited to those as described above. Namely, if the layout of the engine permits the ignition plug to be mounted at the top of the combustion chamber where a pair of roofs intersect with each other, and airflow in the above-indicated direction A or direction G can be produced, the numbers of intake valves and exhaust valves may be any number provided that these valves can be disposed on the respective roofs.

1. A spark-ignition internal combustion engine comprising:
a combustion chamber having a pair of roofs that are inclined so as to be opposed to each other;
at least one intake valve disposed on one of the pair of roofs;
at least one exhaust valve disposed on the other of the pair of roofs;
an ignition plug including a plug body, a center electrode and a ground electrode, the plug body being mounted in a cylinder head at a top of the combustion chamber at which the pair of roofs intersect with each other, the center electrode being provided on the plug body, the ground electrode including an opposed portion and a connecting portion, the opposed portion being opposed to the center electrode via a discharge gap in an axial direction of the plug body, the connecting portion connecting the opposed portion with a housing of the plug body; and
an airflow guide member provided on the housing or a wall surface of at least one of the pair of roofs, the airflow guide member being configured to deflect airflow that passes through the discharge gap at the time of ignition, in a direction that is inclined relative to a reference direction that is perpendicular to a line of intersection of wall surfaces of the pair of roofs as viewed in a direction of a center axis of the cylinder, the airflow being a flow directed from the one of the pair of roofs to the other roof, or a flow directed from the other roof to the one of the pair of roofs, wherein
the connecting portion is located outside a direction of the airflow deflected by the airflow guide member.

2. The spark-ignition internal combustion engine according to claim 1, wherein
the airflow guide member is configured to guide the airflow that passes through the discharge gap at the time of ignition, such that the airflow is directed to one side of a line of the reference direction which passes the center electrode, as viewed in the direction of the center axis of the cylinder, and
the connecting portion of the ground electrode is located on the other side of the line of the reference direction.

3. The spark-ignition internal combustion engine according to claim 1, wherein the ignition plug is configured such that a discharge spark extends a larger distance than a distance from the discharge gap to the wall surface of the other roof as measured in a direction that is perpendicular to the line of intersection of the wall surfaces of the pair of roofs and perpendicular to the center axis of the cylinder.

4. The spark-ignition internal combustion engine according to claim 2, wherein the ignition plug is configured such that a discharge spark extends a larger distance than a distance from the discharge gap to the wall surface of the other roof as measured in a direction that is perpendicular to the line of intersection of the wall surfaces of the pair of roofs and perpendicular to the center axis of the cylinder.
